(19) United States
(12) Patent Application Publication
(10) Pub. No.: US 2026/0298862 A1
(43) Pub. Date: Oct. 1, 2026

(54) DETECTION APPARATUS

(71) Applicant: InnoLux Corporation, Miao-Li County (TW)

(72) Inventors: Yin-Jui LU, Miao-Li County (TW); Wei-Chieh Teng, Miao-Li County (TW); Chen-Tang Li, Miao-Li County (TW); Hao-Jung Huang, Miao-Li County (TW)

(73) Assignee: InnoLux Corporation, Miao-Li County (TW)

(21) Appl. No.: 19/572,905

(22) Filed: Mar. 20, 2026

Related U.S. Application Data
(60) Provisional application No. 63/778,442, filed on Mar. 27, 2025.

(30) Foreign Application Priority Data
Feb. 4, 2026 (CN) 202610159831.6

(51) Int. Cl. G01N 27/30; G01N 27/333

(52) U.S. Cl. CPC G01N 27/301; G01N 27/333

(57) ABSTRACT

The disclosure provides a detection apparatus. The detection apparatus comprises an electrode. The electrode comprises a substrate, an electrode layer, an insulating layer, and an ion layer. The electrode layer is disposed on the substrate. The insulating layer is disposed on the electrode layer and comprises a through hole. The ion layer is disposed on the insulating layer. The electrode layer is in contact with the ion layer through the through hole. The detection apparatus provided by the disclosure can have a relatively long service life.

### CROSS REFERENCE TO RELATED APPLICATION

This application claims the benefit of U.S. Provisional Application No. 63/778,442, filed on Mar. 27, 2025. The content of the application is incorporated herein by reference.

### BACKGROUND OF THE DISCLOSURE

### 1. Field of the Disclosure

The disclosure relates to a detection apparatus, and relates to a reference electrode applied in an electrochemical sensor.

### 2. Description of the Prior Art

A conventional reference electrode for an electrochemical sensor includes a silver/silver chloride (Ag/AgCl) electrode. Its potential sensing depends on the concentration change of chloride ions (Cl−). Based on this, if the concentration of chloride ions on the surface of the reference electrode cannot be kept constant during potential sensing, the sensing result will be affected.

### SUMMARY OF THE DISCLOSURE

The disclosure provides a detection apparatus having a relatively high stability and a relatively long service life. Some embodiments of the disclosure provide a detection apparatus. The detection apparatus comprises an electrode. The electrode comprises a substrate, an electrode layer, an insulating layer, and an ion layer. The electrode layer is disposed on the substrate. The insulating layer is disposed on the electrode layer and comprises a through hole. The ion layer is disposed on the insulating layer. The electrode layer is in contact with the ion layer through the through hole.

### BRIEF DESCRIPTION OF THE DRAWINGS

FIG. 1 is a schematic partial cross sectional view of a detection apparatus according to a first embodiment of the disclosure;

FIG. 2 is a schematic partial cross sectional view of a detection apparatus according to a second embodiment of the disclosure;

FIG. 3 is a schematic partial cross sectional view of a detection apparatus according to a third embodiment of the disclosure;

FIG. 4 is a schematic partial cross sectional view of a detection apparatus according to a fourth embodiment of the disclosure;

FIG. 5 is a schematic partial cross sectional view of a detection apparatus according to a fifth embodiment of the disclosure; and

FIG. 6 is a schematic partial cross sectional view of a detection apparatus according to a sixth embodiment of the disclosure.

### DETAILED DESCRIPTION

Exemplary embodiments of the disclosure will now be described in detail with reference to the accompanying drawings. Wherever possible, the same reference numerals are used in the drawings and the description to refer to the same or similar parts.

The disclosure can be understood by reference to the following detailed description in conjunction with the accompanying drawings. It should be noted that, for the ease of understanding for the reader and for the conciseness of the drawings, many of the drawings in the disclosure only illustrate a part of an electronic device, and specific components in the drawings are not drawn to actual scale. Furthermore, the number and size of each component in the figures are for illustrative purposes only and are not intended to limit the scope of the disclosure.

Certain terms are used throughout the specification and the appended claims to refer to specific components. Those skilled in the art should understand that electronic device manufacturers may refer to the same component by different names. This document does not intend to distinguish between components that have the same function but different names. In the following description and in the claims, the words “comprise”, “contain”, “have”, etc., are open-ended terms and should therefore be interpreted as “including but not limited to . . . ”. Therefore, when the terms “comprise”, “contain”, and/or “have” are used in the description of the disclosure, they specify the presence of corresponding features, regions, steps, operations, and/or components, but do not preclude the presence of one or more other corresponding features, regions, steps, operations, and/or components.

The directional terms mentioned herein, such as “on”, “under”, “front”, “back”, “left”, “right”, etc., are only with reference to the orientation of the drawings. Therefore, the directional terms used are for illustration and not for limitation of the disclosure. In the drawings, each drawing shows the general features of the methods, structures, and/or materials used in a particular embodiment. However, these drawings should not be construed as defining or limiting the scope or nature covered by these embodiments. For example, for clarity, the relative size, thickness, and position of each film layer, region, and/or structure may be reduced or enlarged.

When a corresponding component (e.g., a film layer or a region) is referred to as being “on” another component, it can be directly on the other component, or other components may be present therebetween. On the other hand, when a component is referred to as being “directly on” another component, there are no intervening components therebetween, unless otherwise specified in the specification. In addition, when a component is referred to as being “on” another component, there is an up-down relationship between the two in a top-down view, and this component can be above or below the other component, and this up-down relationship depends on the orientation of the device.

The terms “equal to” or “same”, “substantially” or “approximately” are generally interpreted as being within 20% of a given value or range, or as being within 10%, 5%, 3%, 2%, 1%, or 0.5% of a given value or range.

Ordinal numbers such as “first”, “second”, etc. used in the specification and claims are used to modify elements, and do not in themselves imply or represent that the element(s) have any preceding ordinal number, nor do they represent the order of one element relative to another, or the order in a manufacturing method. The use of these ordinal numbers is only to clearly distinguish an element with a certain name from another element with the same name. The same terms may not be used in the claims and the specification. Accordingly, a first component in the specification may be a second component in the claims.

It should be understood that the features in several different embodiments described below can be replaced, reorganized, and mixed to complete other embodiments without departing from the spirit of the disclosure. As long as the features between the embodiments do not violate the spirit of the disclosure or conflict with each other, they can be arbitrarily mixed and matched.

The electrical connection or electro-connection described in the disclosure may refer to a direct connection or an indirect connection. In the case of a direct connection, the terminals of two circuit components are directly connected or connected to each other by a conductive line segment. In the case of an indirect connection, there are switches, diodes, capacitors, inductors, other suitable components, or a combination of the above components between the terminals of the two circuit components, but it is not limited to this.

In the disclosure, the measurement of thickness, length, width, and area can be obtained by using an optical microscope, and the thickness can be measured from a cross-sectional image in an electron microscope, but is not limited thereto. In addition, there may be a certain error between any two values or directions used for comparison. If a first value is equal to a second value, it implies that there may be an error of about 10% between the first value and the second value; if a first direction is perpendicular to a second direction, the angle between the first direction and the second direction may be between 80 degrees and 100 degrees; if a first direction is parallel to a second direction, the angle between the first direction and the second direction may be between 0 degrees and 10 degrees.

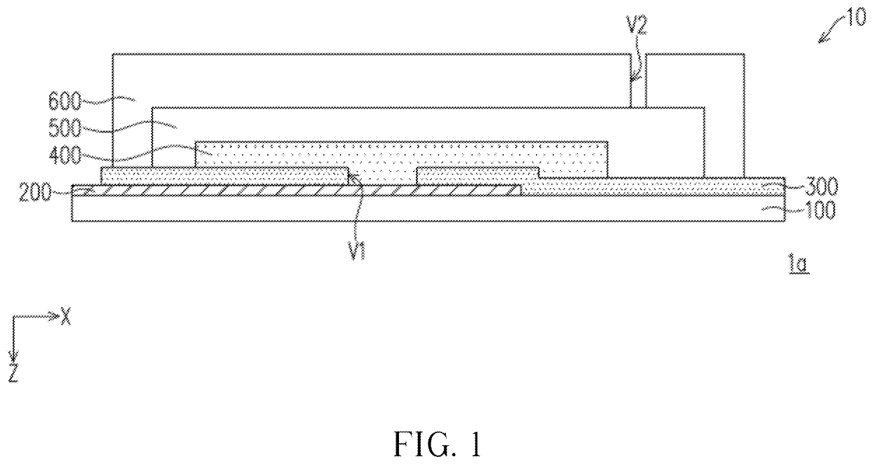

FIG. 1 is a schematic partial cross sectional view of a detection apparatus according to a first embodiment of the disclosure.

Please refer to FIG. 1. In this embodiment, the detection apparatus 1a comprises an electrode 10. The detection apparatus 1a can be, for example, a three-electrode electrochemical sensor, which may comprise a reference electrode, a working electrode, and a counter electrode, but the disclosure is not limited thereto.

The electrode 10 comprises a substrate 100, an electrode layer 200, an insulating layer 300, and an ion layer 400. In this embodiment, the electrode 10 serves as a reference electrode of the detection apparatus 1a.

The substrate 100 can be used to carry the remaining components in the electrode 10 and comprises a suitable insulating material. For example, the material of the substrate 100 may comprise glass or polyethylene terephthalate (PET).

The electrode layer 200 is disposed on the substrate 100 and comprises a suitable conductive material. In this embodiment, the material of the electrode layer 200 comprises silver/silver chloride, but the disclosure is not limited thereto. In some other embodiments, the electrode layer 200 may comprise metal oxide, carbon, and/or other suitable conductive materials.

The insulating layer 300 is disposed on the substrate 100 and may comprise a suitable insulating material. For example, the insulating layer 300 may comprise inorganic insulators, organic polymer insulators, such as silicon dioxide (SiO2), silicon nitride (Si3N4), aluminum oxide (Al2O3), polyimide (PI), epoxy resin, poly-p-xylylene, acrylic resin, but is not limited thereto. In this embodiment, the insulating layer 300 is disposed on the electrode layer 200 and comprises a through hole V1 that exposes at least a part of the electrode layer 200. In some embodiments, the area of the electrode layer 200 exposed by the through hole V1 in a vertical direction Z is greater than or equal to 0.050 mm² and less than or equal to 1.5 cm². In some other embodiments, the width of the through hole V1 in a direction perpendicular to the vertical direction Z (e.g., direction X) is greater than or equal to 1 cm and less than or equal to 1.5 cm. In addition, in some embodiments, the impedance of the insulating layer 300 is greater than 105 ohm.

The ion layer 400 is disposed on the insulating layer 300. In this embodiment, the electrode layer 200 is in contact with the ion layer 400 through the through hole V1. The ion layer 400 can be used to maintain the electrical balance of the electrode layer 200. In this embodiment, the material of the ion layer 400 comprises a salt containing chloride ions. For example, the material of the ion layer 400 may comprise potassium chloride (KCl), sodium chloride (NaCl), calcium chloride (CaCl2), magnesium chloride (MgCl2), ammonium chloride (NH4Cl), or other suitable salts. In some embodiments, the ion layer 400 may also comprise a chloride ion limiting layer, which may comprise a cation exchange material. For example, the material of the ion layer 400 may also comprise perfluorinated sulfonic acid (PFSA), which may be sulfonated polyetheretherketone (SPEEK), sulfonated poly(ether sulfone) (SPES), sulfonated poly(ether sulfone ketone) (SPESK), or sulfonated polyimide (SPI). Alternatively, the material of the ion layer 400 may also comprise polybenzimidazole (PBI). Alternatively, the ion layer 400 may also be a compound comprising a phosphate group (e.g., —PO2H2, —OPO2H2, or —PO3H2), a carboxylic acid group (e.g., —COOH), a sulfonic acid group (e.g., —OSO3H or —OArSO3H), or a hydroxyl group (e.g., —OH).

In this embodiment, the electrode 10 may further comprise a water-conducting layer 500 and a waterproof layer 600.

The water-conducting layer 500 is disposed on the ion layer 400. In this embodiment, the water-conducting layer 500 at least partially covers the ion layer 400. The water-conducting layer 500 can serve as a medium between the ion layer 400 and an external solution, and can allow ion exchange between the ion layer 400 and the external solution to maintain a stable potential.

The waterproof layer 600 is disposed on the water-conducting layer 500. The waterproof layer 600 can be used to substantially separate the ion layer 400 from the external solution, and may comprise a suitable insulating material. In this embodiment, the waterproof layer 600 at least partially covers the water-conducting layer 500 and comprises a through hole V2 that exposes at least a part of the water-conducting layer 500. The through hole V2 of the waterproof layer 600 can be used to allow the external solution to flow to the inner side of the waterproof layer 600. Although not shown in this embodiment, in other embodiments, the through hole V2 can be filled with a material same as or similar to the water-conducting layer 500 and/or the material of the chloride ion limiting layer. In addition, in some embodiments, the water-conducting layer 500 may also comprise a through hole (not shown), which communicates with the through hole V2 of the waterproof layer 600.

In this embodiment, through the arrangement of the insulating layer 300, a part of the electrode layer 200 is in contact with the ion layer 400 through the through hole V1 of the insulating layer 300. Therefore, the through hole V1 of the insulating layer 300 and the through hole V2 of the waterproof layer 600 can have a specific distance in the direction X. Based on this design, the concentration of chloride ions near the through hole V2 of the waterproof layer 600 can decrease only after a relatively long period of use, which helps to extend the time during which the potential of the electrode layer 200 remains stable, and can improve the service life of the detection apparatus 1a of this embodiment.

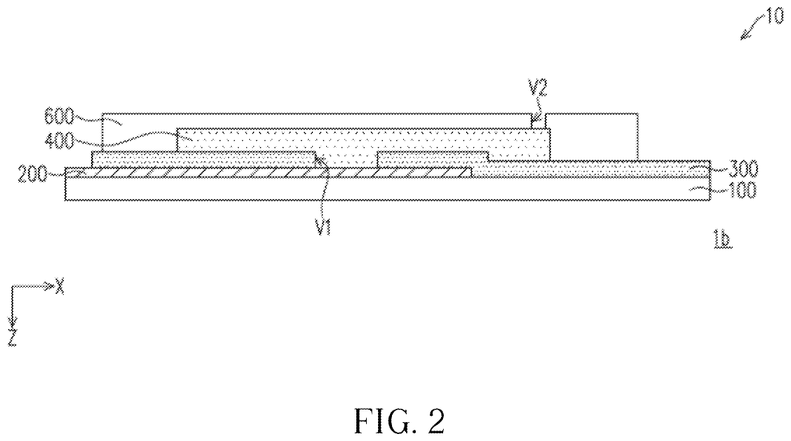

FIG. 2 is a schematic partial cross sectional view of a detection apparatus according to a second embodiment of the disclosure. It should be noted that the embodiment of FIG. 2 can adopt the element labels and part of the content of the embodiment of FIG. 1, wherein the same or similar labels are used to denote the same or similar elements, and the description of the same technical content is omitted.

Please refer to FIG. 2. In this embodiment, the main difference between the detection apparatus 1a and the detection apparatus 1b of the above embodiment is that the detection apparatus 1b does not comprise the water-conducting layer 500.

Specifically, in this embodiment, the waterproof layer 600 is disposed on the ion layer 400. In this embodiment, the waterproof layer 600 at least partially covers the ion layer 400, and its through hole V2 exposes at least a part of the ion layer 400.

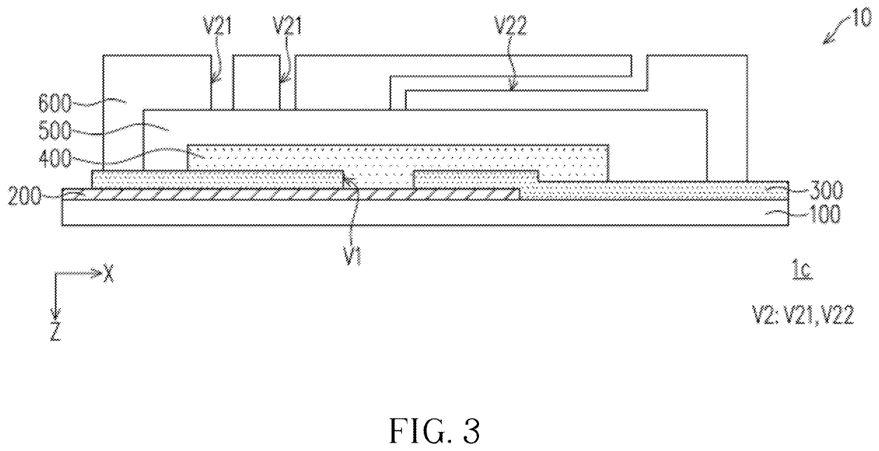

FIG. 3 is a schematic partial cross sectional view of a detection apparatus according to a third embodiment of the disclosure. It should be noted that the embodiment of FIG. 3 can adopt the element labels and part of the content of the embodiment of FIG. 1, wherein the same or similar labels are used to denote the same or similar elements, and the description of the same technical content is omitted.

Please refer to FIG. 3. In this embodiment, the main difference between the detection apparatus 1c and the detection apparatus 1a of the above embodiment is that the through hole V2 of the waterproof layer 600 comprises a first through hole V21 and a second through hole V22.

Specifically, in this embodiment, the first through hole V21 of the waterproof layer 600 is a vertical through hole. That is, the first through hole V21 of the waterproof layer 600 extends in the vertical direction Z. The second through hole V22 of the waterproof layer 600 is a meandering through hole. That is, the second through hole V22 of the waterproof layer 600 includes a winding path in the vertical direction Z. In some embodiments, a plurality of the first through holes V21 and/or the second through holes V22 may be provided in the waterproof layer 600. In this embodiment, through the arrangement of the second through hole V22, it can be used to adjust the reaction time of the electrode layer 200.

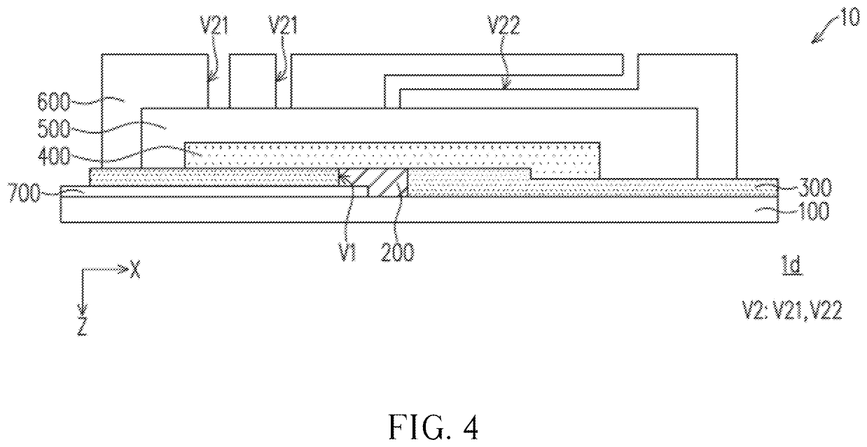

FIG. 4 is a schematic partial cross sectional view of a detection apparatus according to a fourth embodiment of the disclosure. It should be noted that the embodiment of FIG. 4 can adopt the element labels and part of the content of the embodiment of FIG. 3, wherein the same or similar labels are used to denote the same or similar elements, and the description of the same technical content is omitted.

Please refer to FIG. 4. In this embodiment, the main difference between the detection apparatus 1d and the detection apparatus 1c of the above embodiment is that the detection apparatus 1d further comprises a wire 700.

In this embodiment, the wire 700 is disposed between the substrate 100 and the insulating layer 300 and is electrically connected to the electrode layer 200. The wire 700 can be used to electrically connect the electrode layer 200 with an external electrochemical sensor (not shown), to transmit the potential signal of the electrode layer 200 to the external electrochemical sensor. In this embodiment, at least a part of the wire 700 is in contact with the electrode layer 200.

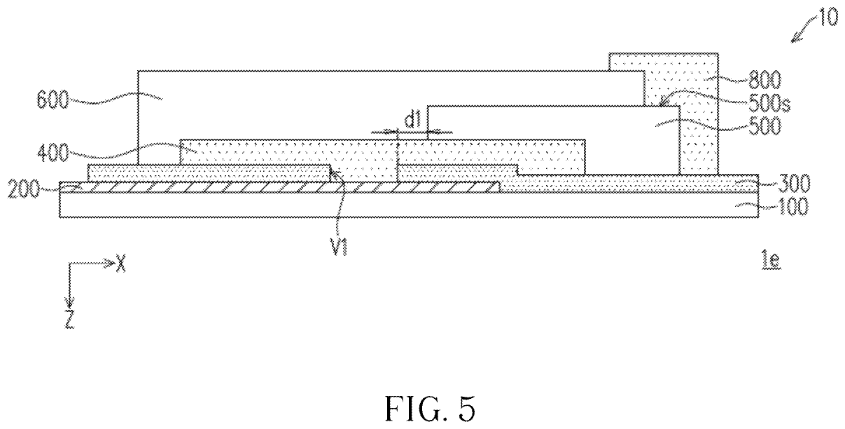

FIG. 5 is a schematic partial cross sectional view of a detection apparatus according to a fifth embodiment of the disclosure. It should be noted that the embodiment of FIG. 5 can adopt the element labels and part of the content of the embodiment of FIG. 1, wherein the same or similar labels are used to denote the same or similar elements, and the description of the same technical content is omitted.

Please refer to FIG. 5. In this embodiment, the main difference between the detection apparatus 1e and the detection apparatus 1a of the above embodiment is that the waterproof layer 600 in the detection apparatus 1e does not comprise a through hole, and at least one side of the waterproof layer 600 exposes a part of the water-conducting layer 500.

Specifically, in this embodiment, the detection apparatus 1e may further comprise an ion layer 800. The ion layer 800 is disposed on the insulating layer 300 and covers the surface 500s of the water-conducting layer 500 exposed by the waterproof layer 600. In some embodiments, the ion layer 800 may cover a part of the waterproof layer 600. The material of the ion layer 800 may be the same as or similar to the material of the ion layer 400, and details are not repeated here.

In addition, in this embodiment, the water-conducting layer 500 is not overlapped with the through hole V1 of the insulating layer 300 in the vertical direction Z. Specifically, in a direction perpendicular to the vertical direction Z (e.g., direction X), a distance d1 between a boundary of the water-conducting layer 500 adjacent to the through hole V1 and the through hole V1 of the insulating layer 300 is less than or equal to 5 mm.

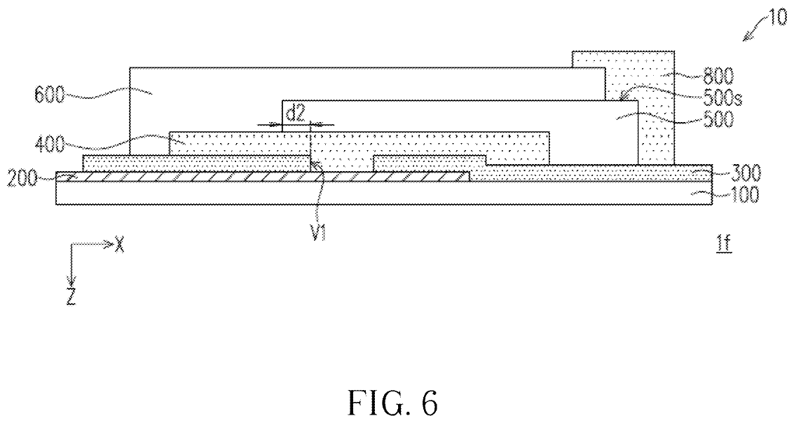

FIG. 6 is a schematic partial cross sectional view of a detection apparatus according to a sixth embodiment of the disclosure. It should be noted that the embodiment of FIG. 6 can adopt the element labels and part of the content of the embodiment of FIG. 5, wherein the same or similar labels are used to denote the same or similar elements, and the description of the same technical content is omitted.

Please refer to FIG. 6. In this embodiment, the main difference between the detection apparatus 1f and the detection apparatus 1e of the above embodiment is that the water-conducting layer 500 in the detection apparatus 1f is overlapped with the through hole V1 of the insulating layer 300 in the vertical direction Z.

In this embodiment, in a direction perpendicular to the vertical direction Z (e.g., direction X), a distance d2 between a boundary of the water-conducting layer 500 adjacent to the through hole V1 and the through hole V1 of the insulating layer 300 is less than or equal to 5 mm.

In summary, in the detection apparatus provided in some embodiments of the disclosure, an insulating layer with a through hole is disposed between the electrode layer and the ion layer, which can limit the contact area between the electrode layer and the ion layer. Based on this, the concentration of ions (e.g., chloride ions) in the ion layer not covered by the insulating layer can decrease only after a relatively long period of use. This helps to extend the time during which the potential of the electrode layer remains stable, thereby increasing the service life of the detection apparatus provided by the disclosure.

Finally, it should be noted that the above embodiments are only for illustrating the technical solutions of the present disclosure, not for limiting them; although the present disclosure has been described in detail with reference to the foregoing embodiments, persons of ordinary skill in the art should understand that they can still modify the technical solutions described in the foregoing embodiments, or make equivalent substitutions for some or all of the technical features therein; and these modifications or substitutions do not cause the essence of the corresponding technical solutions to depart from the scope of the technical solutions of the embodiments of the present disclosure.

What is claimed is:

1. A detection apparatus, comprising:
an electrode, comprising:
a substrate;
an electrode layer, disposed on the substrate;
an insulating layer, disposed on the electrode layer, and comprising a first through hole; and
an ion layer, disposed on the insulating layer,
wherein the electrode layer is in contact with the ion layer through the first through hole.

2. The detection apparatus of claim 1, further comprising:
a water-conducting layer, disposed on the ion layer.

3. The detection apparatus of claim 2, further comprising:
a waterproof layer, disposed on the water-conducting layer.

4. The detection apparatus of claim 3, wherein the waterproof layer comprises a second through hole, and the second through hole exposes the water-conducting layer.

5. The detection apparatus of claim 1, further comprising:
a wire, disposed between the substrate and the insulating layer.

6. The detection apparatus of claim 3, further comprising:
other ion layer, disposed on the insulating layer, wherein the other ion layer covers a surface of the water-conducting layer exposed by the waterproof layer.

7. The detection apparatus of claim 2, wherein the water-conducting layer is not overlapped with the first through hole of the insulating layer in a vertical direction.

8. The detection apparatus of claim 7, wherein a distance between a boundary of the water-conducting layer adjacent to the first through hole and the first through hole is less than or equal to 5 mm.

9. The detection apparatus of claim 2, wherein the water-conducting layer is overlapped with the first through hole of the insulating layer in a vertical direction.

10. The detection apparatus of claim 9, wherein a distance between a boundary of the water-conducting layer adjacent to the first through hole and the first through hole is less than or equal to 5 mm.
